(19) United States
(12) Patent Application Publication
(10) Pub. No.: US 2019/0355253 A1
(43) Pub. Date: Nov. 21, 2019

(54) OPTIPARK - Parking Guidance System

(71) Applicant: McCain, Inc., Vista, CA (US)

(72) Inventor: Nikolaus Stieldorf, Carlsbad, CA (US)

(73) Assignee: McCain, Inc., Vista, CA (US)

(21) Appl. No.: 16/206,658

(22) Filed: Nov. 30, 2018

Related U.S. Application Data
(60) Provisional application No. 62/671,808, filed on May 15, 2018.

(51) Int. Cl. G08G 1/14; G08G 1/065

(52) U.S. Cl. CPC G08G 1/143; G08G 1/065; G08G 1/146

(57) ABSTRACT

An article of manufacture may include at least one machine-readable medium. The medium may include instructions. The instructions, when loaded and executed on a processor, may cause the processor to determine image information from an optical sensor, the image information indicative of movement of one or more vehicles in a parking facility at a first location. The parking facility may include zones including a first zone and a second zone. The instructions may be further configured to cause the processor to, from the image information, determine whether the vehicle entered the first or second zone, and determine a count of vehicles in the first zone. The instructions may be further configured to cause the processor to provide the first count of vehicles in the first zone to a parking server application.

### RELATED PATENT APPLICATION

This application claims priority to commonly owned U.S. Provisional Patent Application No. 62/671,808; filed May 15, 2018; which is hereby incorporated by reference herein for all purposes.

### FIELD OF THE INVENTION

The present disclosure relates to automated tracking of vehicles and, more particularly, to a parking guidance system.

### BACKGROUND

Real-time parking monitoring technologies can be described as indirect and direct. Indirect technologies are based on detecting and classifying vehicles at all ingress and egress points of the parking facility and summing the difference over accumulated counts at specified time intervals. The general problem with technologies based on ingress-egress count detection is that small counting and vehicle classification errors can accumulated over time. One example of an indirect technology includes magnetometers embedded in the pavement at the egress and ingress locations of the parking facility to estimate occupancy by subtracting the two counts in real-time. Another example of an indirect technology uses camera sensors at the entrance and exit to a parking facility. The camera sensors utilize “trip-wire” detectors to sense vehicle presence and motion, and vehicle length classification. The detection accuracy can be impaired by such factors as poor lighting, vehicle color, shadows, headlights, tail-gating (wherein vehicles enter closely behind one another, including entering before mechanical barriers may close behind a first vehicle), and flying birds. Furthermore, “trip-wire” counting cannot determine actual occupancy for undisciplined parking, which occurs when drivers straddle parking lane line designations, differ in their maneuvering skills, or where lanes are not delineated.

Various methodologies directly monitor individual parking spaces using camera sensors. Some have used a foreground/background blob segmentation algorithm based on time-variant mixture of Gaussians combined with shadow removal. One approach ortho-rectifies a 2D camera view of vehicle parking spaces into a top-down viewpoint before segmenting each parking space. A sliding window is passed over the lot to encode the detection result based on probabilities of occupancy using mean color of the space compared to an a priori color feature of the empty space. Other approaches entail computing color histograms of parking space regions defined a priori or using aerial images to train an SVM linear classifier.

### SUMMARY

Embodiments of the present disclosure include an article of manufacture. The article may include at least one machine-readable medium. The medium may include instructions. The instructions, when loaded and executed on a processor, may cause the processor to determine image information from an optical sensor, the image information indicative of movement of one or more vehicles in a parking facility at a first location. The parking facility may include a plurality of zones including a first and second zone. The instructions may be further configured to cause the processor to, from the image information, determine whether a vehicle in the parking facility then enters the first zone or the second zone, and determine a first count of vehicles in a first zone of the parking facility, the first zone including a plurality of parking spaces. The instructions may be further configured to cause the processor to provide the first count of vehicles in the first zone to a parking server application.

In combination with any of the above embodiments, the article may further include instructions to determine the first count of vehicles in the first zone from image information detected parallel to ground. In combination with any of the above embodiments, the article may further include instructions to determine the first count of vehicles from the image information from an intersection in the parking facility. In combination with any of the above embodiments, the article may further include instructions to determine the first count of vehicles from the image information from vehicles making a turn. In combination with any of the above embodiments, the article may further include instructions to determine the first count of vehicles from the image information from vehicles moving in multiple directions in an intersection in the parking facility. In combination with any of the above embodiments, the article may further include instructions to add the first count of vehicles of the first zone to a second count of vehicles from additional image data collected at a second location. In combination with any of the above embodiments, the article may further include instructions to cause the processor to determine a second count of vehicles in a second zone of the parking facility from image information from the same optical sensor.

Embodiments of the present disclosure may include one or more apparatuses or a system. The apparatuses or system may include an optical sensor, a processor, and any of the articles of manufacture from above.

Embodiments of the present disclosure may include methods performed by any of the articles of manufacture of the above embodiments when loaded on a processor.

### BRIEF DESCRIPTION OF THE DRAWINGS

FIG. 1 is an illustration of a system for parking guidance, according to embodiments of the present disclosure.

FIG. 2 illustrates an example layout of a facility using a system for parking guidance, according to embodiments of the present disclosure.

### DETAILED DESCRIPTION

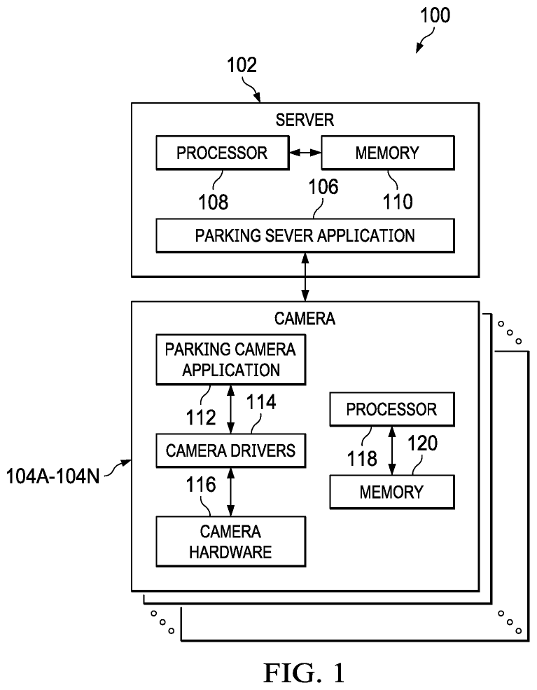

FIG. 1 is an illustration of a system 100 for parking guidance, according to embodiments of the present disclosure.

System 100 may include a server 102 and one or more cameras 104. System 100 may include any suitable number and kind of cameras 104, shown in FIG. 1 as cameras 104A . . . 104N. Each camera may be implemented in a same, similar, or different manner. Although cameras 104 are illustrated in FIG. 1, cameras 104 may be implemented within any suitable electronic device, such as a kiosk, computer, server, or mobile device. In various embodiments, server 102 may separately implement one of cameras 104 within server 102, or one of cameras 104 may implement server 102.

Server 102 may include a parking server application 106. Parking server application 106 may be configured to coordinate information received from one or more of cameras 104 to determine where parking may be available in a parking facility. Each camera 104 may include a parking camera application 112. Parking camera application 112 may be configured to process information from a single camera or view. Parking camera application 112 may be configured to access camera hardware 116, such as a CCD (charged coupled device) CMOS (complementary metal-oxide-semiconductor) sensor or array of sensors. Parking camera application 112 may be configured to access camera hardware 116 though any suitable combination of camera drivers 114. Parking camera application 112 may receive image data from camera hardware 116. Parking camera application 112 may perform image processing on such image data to determine whether vehicles in the parking facility have entered a particular zone, exited a particular zone, turned left, turned right, proceeded forward, or proceeded backward in terms of the image. Parking camera application 112 may provide such information, individually or in the aggregate, to parking server application 106. Parking server application 106 and cameras 104 may be communicatively coupled in any suitable manner, such as by a telecommunications network, the Internet, an intranet, or cabling. Cameras 104 may be fitted with any suitable lenses or optics. For example, cameras 104 may utilize a fish-eye or wide-angle camera lens to better achieve a wide field of view.

Parking server application 106, using location information about camera 104, may be configured to compile information to know how many vehicles are in a given zone of the parking facility. Furthermore, parking server application 106 may be configured to access information about a total number of parking spots in a given zone to determine how many parking spots are still unused within the given zone. Parking server application 106 may be configured to communicate availability of a given zone to other entities.

In various embodiments, some or all of the operation or configuration of parking server application 106 may be performed by parking camera application 112. Furthermore, in various embodiments some or all of the operation or configuration of parking camera application may be performed by parking server application 106. For example, parking camera application 112 may track a number of given vehicles that have entered or exited a zone, and communicate the number to parking server application 106. In another example, parking camera application 112 may provide image data to parking server application 106, which may perform image processing to determine whether a vehicle has entered, exited, or turned.

Parking server application 106, parking camera application 112, and camera drivers 114 may be implemented in any suitable manner, such as by software, instructions for execution on a processor, libraries, routines, applications, or scripts. Instructions for configuring the operation of parking server application 106, parking camera application 112, and camera drivers 114 may reside on respective memories 110, 120. The instructions, when loaded and executed on respective processors 108, 118, may cause the elements to perform the functionality of the present disclosure. Processors 108, 118 may be implemented by one or more microprocessors, microcontrollers, field programmable gate arrays, application specific integrated circuits, or other suitable circuitry.

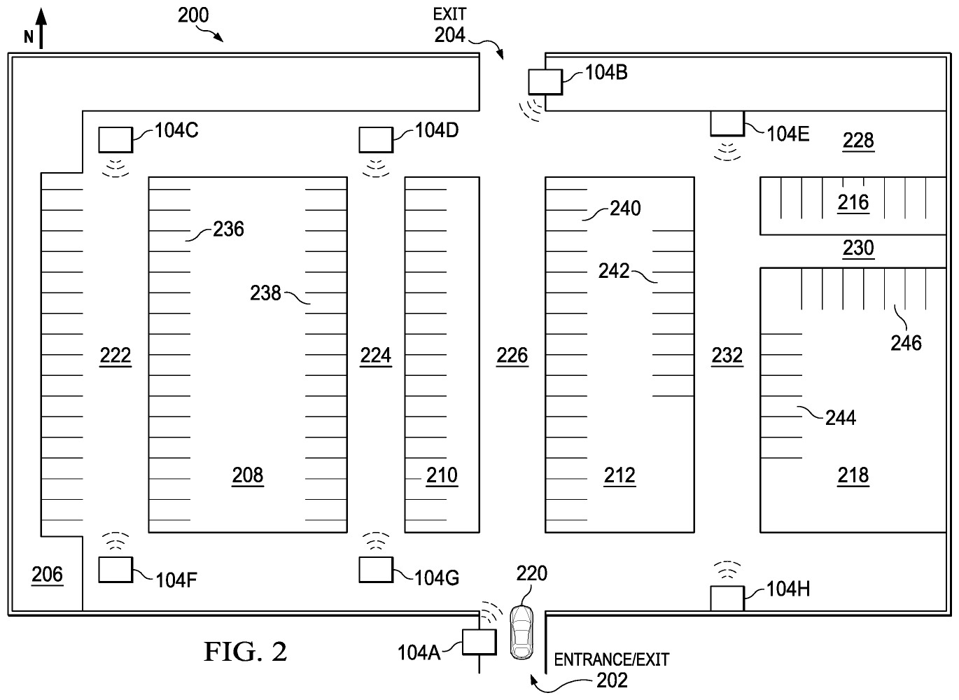

FIG. 2 illustrates an example layout of a facility 200 using a system for parking guidance, according to embodiments of the present disclosure. Facility 200 is shown as an overhead map oriented along the cardinal directions.

Example placement of cameras 104 are shown in FIG. 2. Parking server application 102 is not shown but may be implemented within facility 200, within an instance of a camera 104, or outside of facility 200. Although a specific number and orientation of cameras 104 are shown, facility 200 may include any suitable number and orientations of cameras. Each of cameras 104 are shown with an example orientation denoted by waves emitting from cameras 104. However, cameras 104 may include a wider orientation in which to perceive input, include a 360-degree view, according to the implementation of

Cameras 104 may track the movement of a vehicle as it enters or exits various zones of facility 200. Zones may include parking zones 222, 224, 226, 228, 230, 232. Each parking zone may include multiple parking spots. Moreover, a combination of parking zones may be logically combined. For example, a west-side zone may include zones 222, 224. An east-side zone may include zones 228, 230, 232. A central zone may include only zone 226. Moreover, parking spots may be grouped in sub-lots 206, 208, 210, 212, 216, 218. Sub-lots may include multiple aisles. For example, sub-lot 208 may include aisles 236, 238; sub-lot 212 may include aisles 240, 242; and sub-lot 218 may include aisles 244, 246. A given zone, sub-lot, and aisle may be coextensive. However, a give sub-lot may include aisles belonging to different zones.

For example, zone 222 may include sub-lot 206 and aisle 236 of sub-lot 208. Zone 224 may include aisle 238 of sub-lot 208 and sub-lot 210. Zone 226 may include aisle 240 of sub-lot 212. Zone 228 may include sub-lot 216. Zone 230 may include aisle 246 of sub-lot 218. Zone 232 may include aisle 242 of sub-lot 212 and aisle 244 of sub-lot 218. Although these zones have been defined for the example of FIG. 2, facility 200 may be divided in any suitable manner.

Cameras 104 may be located at or within view of decision points between zones. The number of cameras 104 used may depend upon the ability of a given camera 104 to detect movement between or at decision points between zones. For example, camera 104A might be able to detect entrance or exit of a vehicle at entrance/exit 202. Furthermore, camera 104A might be able to detect a turn to the east or a turn to the west near entrance exit 202. However, camera 104A might not have sufficient range, or may be placed at insufficient angle, to detect exit or turning near exit 204. This may be performed instead by, for example, camera 104B. If camera 104A does have sufficient range to detect exit or turning near exit 204, camera 104B might not be needed. Cameras 104A, 104B may further detect whether parking has occurred in zone 226.

Cameras 104 may be configured to process vehicle 220 movement substantially vertically. That is, a given camera 104 may have a substantially vertical physical camera lens orientation in relation to the underlying surface. This deviation should not exceed 20 degrees in any direction, or 30 degrees deviation from the horizontal plane. Thus, devices such as license plate recognition (LPR) cameras might not be used. The substantially vertical position may be in contrast to a substantially overhead view. Within a two-dimensional field of data for a given camera, movement away from the camera may be detected by the vehicle moving through a top line of the two-dimensional field of data. Movement to the left may be detected by the vehicle moving through a left line of the two-dimensional field of data. Movement to the right may be detected by the vehicle moving through a right line of the two-dimensional field of data.

Object detection of vehicles may be performed in any suitable manner. Cameras 104 may be configured to perform pattern-matching to distinguish vehicles to park from other entities, such as persons or shuttle buses. In another example, size of objects may be used to distinguish between vehicles to park, persons, or shuttle buses. A size of a detected object may be made through an edge determination of an outline of the object and inferences made about its size based upon the outline and an estimate of the distance of the object to the camera. Furthermore, a size of the detected object may be made based upon a relative size of the outline to the entire view. A threshold of object size in comparison to the overall image may be established. The threshold may define an object size above which the object is to be tracked. The threshold may be adjusted based on the mounting height. For example, the higher the camera is mounted, the lower the threshold will be because vehicles are then be smaller compared to the overall image. Using this technique, a bus or vehicle might be tracked, but pedestrians, bicycles, or motorbikes might not counted and tracked. A maximum threshold may be employed, above which tracking might not be performed. For example, a shuttle bus would be counted using only the minimum threshold, might not be counted if a maximum threshold were used.

Camera 104C may detect a vehicle entering into or turning from zone 222. Similarly, camera 104F may detect a vehicle entered into or turning from zone 222 from the southern end of zone 222. Camera 104D may detect a vehicle entering into or turning from zone 224. Similarly, camera 104G may detect a vehicle entered into or turning from zone 224 from the southern end of zone 224. Camera 104E may detect a vehicle entering or leaving zones 228, 230, or 232. Camera 104H may detect a vehicle entered or leaving zone 232.

Camera 104A may detect that a vehicle 220 has moved from south to north at entrance/exit 202 and thus entered into facility 200. As vehicle 220 moves north out of range of camera 104A, camera 104A may determine that vehicle 220 has entered zone 226. If vehicle 220 deviates from the vertical projection to the left, camera 104A may determine that vehicle 220 has turned west towards camera 104G. If vehicle 220 deviates from the vertical projection to the right, camera 104A may determine that vehicle 220 has turned east towards camera 104H. If vehicle 220 moves from north to south out of range, camera 104A may determine that vehicle 220 has existed facility 200.

Tracking for movement of a vehicle may be performed through aggregate counts of individual cameras. For example, as a vehicle moves into the line of view from the south of camera 104A, camera 104A may increase the count of total vehicles in facility 200 by one. If camera 104A observes movement of a vehicle north, out of range, camera 104A may increment a count of vehicles in zone 226 by one. If camera 104B observes a vehicle moving from the south in zone 226 to the north and out exit 204, camera 104B may decrement a count of total vehicles in facility 200 by one. The total number of vehicles in facility 200 might require respective counts from both camera 104A and 104B, or from an aggregation of counts from another suitable combination of cameras. Similarly, if camera 104B observes movement of a vehicle moving from the south in zone 226 to the north and out exit 204, or turning to the east or west, camera 104B may decrement a count of total vehicles in zone 226 by one. If camera 104B observes movement of a vehicle moving from the east or the west and turning south, camera 104B may increment a count of total vehicles in zone 226 by one. The total number of vehicles in zone 226 might require perspective counts from both camera 104A and 104B, or camera 104A and camera 104B might have access to a common counter.

Tracking for zone 222 may be performed by camera 104F and camera 104C. If camera 104F observes a vehicle moving from the east to the west and turning north into zone 222, camera 104F may increment a count of vehicles for zone 222. If camera 104C observes a vehicle moving from the east to the west and turning south into zone 222, camera 104C may increment a count of vehicles for zone 222. If camera 104F observes a vehicle moving from the north to south and turning east, camera 104F may decrement a count of vehicles for zone 222. If camera 104C observes a vehicle moving from the south to the north and turning east, camera 104C may decrement a count of vehicles for zone 222. The total number of vehicles in zone 222 might require perspective counts from both cameras 104C, 104F, or cameras 104C, 104F might have access to a common counter.

Tracking for zone 224 may be performed by camera 104D and camera 104G. If camera 104G observes a vehicle moving from the east to the west, or from the west to the east, and turning north into zone 222, camera 104G may increment a count of vehicles for zone 224. If camera 104D observes a vehicle moving from the east-west or west-east and turning south into zone 224, camera 104D may increment a count of vehicles for zone 224. If camera 104G observes a vehicle moving from the north to south and turning east or west, camera 104G may decrement a count of vehicles for zone 222. If camera 104D observes a vehicle moving from the south to the north and turning east or west, camera 104C may decrement a count of vehicles for zone 224. The total number of vehicles in zone 224 might require perspective counts from both cameras 104G, 104D, or cameras 104C, 104F might have access to a common counter.

In one embodiment, cameras 104G, 104D may further process tracking for zone 222. If camera 104G observes a vehicle moving from east to west without turning north, camera 104G may increment a count for zone 222. If camera 104G observes a vehicle moving from west to east without turning north, camera 104G may decrement a count for zone 222. If camera 104D observes a vehicle moving from east to west without turning south, camera 104D may increment a count for zone 222. If camera 104D observes a vehicle moving from west to east without turning south, camera 104G may decrement a count for zone 222. The total number of vehicles in zone 222 might require perspective counts from both cameras 104D, 104G, or cameras 104D, 104G might have access to a common counter. Cameras 104G, 104D might thus preclude a need for cameras 104C, 104F.

Tracking for zone 228 may be performed by camera 104E. If camera 104E observes a vehicle moving from west to east without turning south, camera 104E may increment a count of vehicles for zone 228. If camera 104E observes a vehicle moving from east to west, camera 104E may decrement a count of vehicles for zone 228.

Tracking for zone 230 may be performed by camera 104E. If camera 104E observes a vehicle moving west-east or east-west then turning south, then turning east, camera 104E may increment a count of vehicles for zone 230. If camera 104E observes a vehicle moving east from zone 230, camera 104E may decrement a count of vehicles for zone 230.

Tracking for zone 232 may be performed by camera 104E and camera 104H. If camera 104E observes a vehicle moving west-east or east-west then turning south, without subsequently turning east, camera 104E may increment a count of vehicles for zone 232. If camera 104E observes a vehicle moving north from zone 232, camera 104E may decrement a count of vehicles for zone 232. If camera 104H observes a vehicle turning north, camera 104H may increment a count of vehicles for zone 232. If camera 104H observes a vehicle moving south from zone 232, camera 104H may decrement a count of vehicles for zone 232. The total number of vehicles in zone 232 might require perspective counts from both cameras 104E, 104H, or cameras 104E, 104H might have access to a common counter.

During tracking, a given camera may include a negative count for a given zone at an instant of time. Furthermore, cameras 104 might not count the same, identical vehicle leaving or entering a zone. In addition, a vehicle may enter a zone and leave the zone without actually parking in a parking space. In such a situation, the vehicle may trigger appropriate increments or decrements of respective cameras even though a parking space for the vehicle is not actually occupied. A vehicle that enters a zone to take a last parking space therein may trigger counting the vehicle upon entry to the zone, well before the parking space is actually taken. Thus, other vehicles arriving subsequent to the first vehicle entering the zone but before the first vehicle actually takes the parking space will nonetheless be informed that the parking space is unavailable.

Parking server application 106 may track a number of available number of spaces in a given zone or group of zones. For a given zone, parking server application 106 may know a total number of spaces. For example, for zone 222, sub-lot 206 may include x spaces and aisle 236 may include y spaces. Thus, zone 222 may have a quantity (x+y) of spaces. A number of vehicles detected by cameras 104 in zone 222 may be compared against the total quantity of spaces.

Such a comparison may be made for each of the zones in facility 200. The comparison and tracking may be performed dynamically. The tracking may be made at decision points or intersections in facility 200. In comparison to other solutions, the tracking might not be made for individual parking spaces, but instead to a plurality of zones of parking in facility 200. The zones may include particular aisles of parking spaces. The aisles may include a single side or a double side of a pathway in facility 200. Facility 200 may represent a single floor of a larger structure. The elements of FIG. 2 may be repeated for a structure that includes multiple floors.

Information about usage of particular zones may be tracked over time. The average or median occupancy of a given zone in a day, week, or other designated time period may be recorded by parking sever application 106. Moreover, instantaneous information of availability of a given zone may be provided to users of facility 200. For example, an available number of unused spaces or percentage of occupancy for a zone or a group of zones may be displayed on reader boards at intersections or decision points in facility 200. The reader boards may be implemented by any suitable combination of processors, analog circuitry, digital circuitry, or electronic display. The zone or group of zones may be referenced by an appropriate label (such as “east lot”, “green lot”, “aisle 3”, etc.). In another example, an available number of unused spaces or percentage of occupancy for a zone or a group of zones may be sent to individual vehicles. The information may be sent to an infotainment head unit or similar electronic device, or to an end user's mobile device. Communication between parking server application 106 and other entities may be made by, for example, Bluetooth, WiFi, IEEE 802.11, or any other acceptable communications protocol.

The present disclosure has been described in terms of one or more embodiments, and it should be appreciated that many equivalents, alternatives, variations, and modifications, aside from those expressly stated, are possible and within the scope of the disclosure. While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit may fulfill the functions of several items recited in the claims.

The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

We claim:

1. An article of manufacture, comprising at least one machine-readable medium, the medium including instructions, the instructions, when loaded and executed on a processor, cause the processor to:
determine image information from an optical sensor, the image information indicative of movement of one or more vehicles in a parking facility at a first location, the parking facility including a first zone and a second zone, wherein the first zone and the second zone each include a plurality of parking spaces;
from the image information, determine:
whether a given vehicle in the parking facility then enters the first zone or the second zone; and
a first count of vehicles in the first zone of the parking facility; and
provide the first count of vehicles in the first zone to a parking server application.

2. The article of claim 1, further comprising instructions to determine the first count of vehicles in the first zone from image information detected parallel to ground.

3. The article of claim 1, further comprising instructions to determine the first count of vehicles from the image information from an intersection in the parking facility.

4. The article of claim 1, further comprising instructions to determine the first count of vehicles from the image information from vehicles making a turn.

5. The article of claim 1, further comprising instructions to determine the first count of vehicles from the image information from vehicles moving in multiple directions in an intersection in the parking facility.

6. The article of claim 1, further comprising instructions to add the first count of vehicles of the first zone to a second count of vehicles from additional image data collected at a second location.

7. The article of claim 1, further comprising instructions to cause the processor to determine a second count of vehicles in a second zone of the parking facility from image information from the same optical sensor.

8. An apparatus, comprising:
an optical sensor;
a processor;
an article of manufacture, comprising at least one machine-readable medium, the medium including instructions, the instructions, when loaded and executed on the processor, cause the processor to:
determine image information from an optical sensor, the image information indicative of movement of one or more vehicles in a parking facility at a first location, the parking facility including a first zone and a second zone, the first zone and the second zone each including a plurality of parking spaces;
from the image information, determine:
whether a given vehicle in the facility then enters the first zone or the second zone;
a first count of vehicles in a first zone; and
provide the first count of vehicles in the first zone to a parking server application.

9. The apparatus of claim 8, wherein the article further includes instructions to determine the first count of vehicles in the first zone from image information detected parallel to ground.

10. The apparatus of claim 8, wherein the article further includes instructions to determine the first count of vehicles from the image information from an intersection in the parking facility.

11. The apparatus of claim 8, wherein the article further includes instructions to determine the first count of vehicles from the image information from vehicles making a turn.

12. The apparatus of claim 8, wherein the article further includes instructions to determine the first count of vehicles from the image information from vehicles moving in multiple directions in an intersection in the parking facility.

13. The apparatus of claim 8, wherein the article further includes instructions to add the first count of vehicles of the first zone to a second count of vehicles from additional image data collected at a second location.

14. The apparatus of claim 8, wherein the article further includes instructions to determine a second count of vehicles in a second zone of the parking facility from image information from the same optical sensor.

15. A method, comprising:
determining image information from an optical sensor, the image information indicative of movement of one or more vehicles in a parking facility at a first location, the parking facility including a first zone and a second zone, the first zone and the second zone each including a plurality of parking spaces;
from the image information, determining:
whether a given vehicle in the parking facility then enters the first zone or the second zone; and
a first count of vehicles in the first zone of the parking facility; and
providing the first count of vehicles in the first zone to a parking server application.

16. The method of claim 15, wherein the first count of vehicles in the first zone is determined from image information detected parallel to ground.

17. The method of claim 15, wherein the first count of vehicles is determined from the image information from an intersection in the parking facility.

18. The method of claim 15, wherein the first count of vehicles is determined from the image information from vehicles making a turn.

19. The method of claim 15, wherein the first count of vehicles is determined from the image information from vehicles moving in multiple directions in an intersection in the parking facility.

20. The method of claim 15, wherein the first count of vehicles of the first zone is configured to be added to a second count of vehicles from additional image data collected at a second location.
